(19) United States
(12) Patent Application Publication
(10) Pub. No.: US 2003/0099355 A1
(43) Pub. Date: May 29, 2003

(54) Security system for digital cinema

(75) Inventor: Paul Moroney, Olivehain, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA

(21) Appl. No.: 09/997,521

(22) Filed: Nov. 28, 2001

(51) Int. Cl. H04N 7/167

(52) U.S. Cl. 380/210

(57) ABSTRACT

A system and method for secure delivery and playback of content at a theater complex domain. The domain receives encrypted and compressed content from a studio domain. The theater complex domain comprises at least a projection unit operable to render decompressed digital video content, and a security module removably coupled to the projection unit. The security module includes at least a decompression unit operable to produce decompressed digital video content. The security module further includes a decryption unit coupled to the decompression unit that is operable to produce unencrypted compressed digital video content that is then processed by the decompression unit. The security module further includes a watermark unit coupled to the decompression unit operable to produce the decompressed digital video content rendered by the projection unit that includes a watermark embedded therein. The watermark is used to uniquely identify the projection unit to which the security module is removably coupled, or alternatively, to uniquely identify the security module itself. The security module is physically locked in a tamper resistant container, and is preferably physically locked inside or onto the projection unit to which it is removably coupled. A receiver is coupled to the security module in order to receive the compressed digital video content from the content source or studio domain. The receiver is coupled to the security module, for example, by an internet protocol network. The receiver may receive the compressed digital video content from the studio domain in real-time, or alternatively, a file server may store the compressed digital video content and later provide it to the security module when it is to be rendered. A connection path to the content source may be provided in order to periodically report back to the content source.

### BACKGROUND OF THE INVENTION

The present invention relates generally to the field of communication systems and cryptography and more specifically a secure communication system and method for digital cinema, the secure system and method for supporting distribution and rendering of digital cinema video content that incorporates multimedia compression and decompression and security technology.

Digital cinema is an evolving field; it needs an approach that can evolve with technology, yet still provide a secure approach, with high quality. Conventional solutions may be built which are either less secure or which need to be completely replaced as technology progresses.

The security algorithms and compression approaches must be standards-based, and state of the art. In the present embodiment, MPEG-4 is used for video and audio compression, RTP (real-time transport protocol) for transport over IP (Internet protocol) networks, either real time or non-real time and stored at the theater servers, and the Advanced Encryption Standard for encryption of the multi-media.

Digital Cinema is an evolving field. The movie studios want an approach that can provide quality, security, and low distribution costs. In fact, their primary motivation often is the reduction in distribution costs for digital content as compared to film duplication. However, digital content requires that the theaters install digital servers, and digital electronic projectors, which are quite costly. When the complete change in equipment is compared with the new distribution approach, and the merits of digitally protected content is considered, in which quality is excellent for every showing, and the fact that the choice of what to project can change for each showing, the result is a shift in the total industry paradigm. Thus, the studios are treating this as revolutionary, working with standards groups to redefine everything about the process. The studios want better quality, lower cost, and better security as compared to today's film based approach.

Yet conventional technology is not there with the perfect answer, and thus an approach is needed that can evolve with the technology and time. Since the state of the art in quality and security will change, so must the system. A need exists for resolving the aforementioned disadvantages of conventional systems and the present invention meets this need.

### BRIEF SUMMARY OF THE INVENTION

According to a first aspect of the present invention, a digital cinema distribution and rendering approach in which adequate security measures protect the digital content and in which the system can be easily upgraded or adapted to changing standards is provided.

Theater side equipment according to the present invention is built as a module that plugs directly into the theater projector, and locks either inside the projector or onto the projector. Preferably, the module will receive IP packets of MPEG video and audio content, and decrypt them and decompress them inside the module. A watermark specific to the projector is also added inside the module, for maximum security. When the compression techniques improve, the module according to the present invention need only be replaced, not the entire projector as might otherwise be required. This module needs to be inside the projector for maximum secure identification of that projector as the location of decryption, decompression, and display. Thus, according to the present invention, a pirate is prevented from accessing the clear digital content electronically. If the pirate films the displayed movie, the watermark is present for identification. If security algorithms change, again, only the module must be replaced.

According to an aspect of the present invention, a theater complex domain comprises a projection unit operable to render decompressed digital video content, and a security module removably coupled to the projection unit. The security module includes at least a decompression unit operable to receive compressed digital video content and to produce decompressed digital video content. Preferably, the security module further includes a decryption unit coupled to the decompression unit that is operable to receive encrypted compressed digital video content and to produce unencrypted compressed digital video content that is then processed by the decompression unit. Furthermore, the security module further includes a watermark unit coupled to the decompression unit operable to receive either the compressed digital signal; or the decompressed digital video content produced by the decompression unit, and to alter the compressed or decompressed digital video content, such that the decompressed digital video content rendered by the projection unit includes a watermark embedded therein. Preferably, the watermark is used to uniquely identify the projection unit to which the security module is removably coupled. Alternatively, the watermark is used to uniquely identify the security module itself.

According to another aspect of the present invention, the security module is physically locked in a tamper resistant container. Furthermore, the security module is preferably physically locked to the projection unit to which it is removably coupled. In addition, a global positioning circuit may be embedded in the projection unit according to the present invention.

A receiver is coupled to the security module in order to receive the compressed digital video content from the content source. The receiver is coupled to the security module, for example, by an internet protocol network. In an embodiment of the present invention, the receiver is operable to receive the compressed digital video content from the content source in real-time, and to transmit the compressed digital video content directly to the security module, such that the projection unit renders digital video content corresponding to the compressed digital video content nearly concurrently with reception by the receiver of the compressed digital video content. According to another aspect of the present invention, a file server is coupled to the receiver and to the security module. The file server is operable to store compressed digital video content received from the receiver, and is operable at a later time or times to provide the compressed digital video content to the security module for rendering by the projection unit. For example, the receiver can be implemented as a satellite receiver, a fiber optic transceiver, a T1, a DS3 etc. without limitation. In the present embodiment, the compressed digital video content is received by the receiver in the form of internet protocol packets.

According to yet another aspect of the present invention, a transmitter is coupled to the security module operable to transmit information on its usage to the content source. For example, the transmitter may constitute a connection path to an internet protocol network from which the content source can be reached. For example, the security module may be operable according to the present invention to detect unauthorized attempts to tamper with it, and then the information transmitted to the content source includes notification of unauthorized attempts to tamper it. The security module may be operable to periodically report to the content source, so that failure to report back to the content source can be interpreted by the content source as a security breach.

The security module according to the present invention includes at least a decompression unit is operable to receive compressed digital video content and to produce decompressed digital video content. A security container is coupled to and encloses the decompression unit and is physically removably coupled to the projection unit.

These and other features, aspects, and advantages of the present invention will be apparent from the Detailed Description of the Invention in conjunction with the Figures.

### BRIEF DESCRIPTION OF THE DRAWINGS

FIG. 1 is an exemplary block diagram of a studio domain in which encrypted compressed digital video content can be distributed in accordance with an embodiment of the present invention.

FIG. 2 is an exemplary block diagram of a theater complex domain which encrypted compressed digital video content can be received in accordance with an exemplary embodiment of the present invention.

FIG. 3 is an exemplary block diagram of a projection system in accordance with an embodiment of the present invention.

FIG. 4 illustrates an exemplary functionality performed within the projection system of FIG. 3.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### DETAILED DESCRIPTION OF THE INVENTION

Some of the important issues involved in digital cinema include the studio relationships with the digital cinemas, the control of the studios and digital cinemas, the standards involved, the projection technology utilized, the compression techniques utilized, and the security measures implemented to protect the digital content.

With regard to the coding of the source video content, there is a general thrust away from consumer coding technologies. There is no single answer, and the solutions used will typically evolve, and not be limited by the projector technology. Distribution and projection systems must incorporate real-time aspects when necessary. Off-line encoding is typical for films.

Conventional standards focus on MPEG-2 and MPEG-4 encoding. The intention is to extend the quality beyond ATSC HD in the systems according to the present invention. For example, 1920 by 1080 24 P (60 P) could be base film compression, 50 Mbps minimum, with 1080 i reserved for real-time encoding. Higher quality modes would be defined as well, using the same compression technology, for future evolution. VBR compression leverages investments and expertise in high quality SD and HD compression. According to the present invention, compressed film distribution via satellite, fiber, T1, DS3 or the like can be accomplished as standard file transfer, using TCP/IP, or as multicast UDP. At 50 Mbps, a two-hour film requires approximately 45 GB of storage. According to the present invention, the two-hour film can be stored in a server array at the theater, with decompression at the projector.

In order to ensure that the content is secure regardless of the distribution methodology, the security requirements may include content encryption. Content encryption prevents the content from being used by anyone not possessing a valid key. Content “ideally” is only decrypted at the final destination. An operationally practical, yet highly secure, key management system can be employed. Watermarking of the content can be performed for persistent protection (protection that survives past decryption). Watermarking protects the content by applying a (nearly) non-removable, non-forgeable mark. Attempts to remove or alter the watermark result in the content quality being degraded beyond usability. The watermarking process should be efficient and robust, given the compression choice.

The security proposal according to the present invention includes encryption at the content source, and decryption within the projection system. Files stored in the theater file server are thus encrypted. Playback is thus controlled by the theater, while decryption is controlled by the studio. A source watermark will usually be inserted by the content source in order to label content. According to the present invention, a projector watermark (fingerprint) is embedded into the video content in order to identify playout. Physically protected hardware is in the projector according to the present invention.

According to the present invention, the requirement of the security container is to “protect the content when it is in a form that is easily stolen and easily transported”. Projector watermarking must be performed in a secure container. Decryption and decompression must be performed in the “same secure container”. The secure container must meet similar security requirements to FIPS 140 level 3 or 4.

The studio and movie industries are not enormous. If the studios redefine all the relevant technology components as new, the costs of the system development and product evolution will be enormous. As far as is possible, these industries must exploit existing approaches, which consist primarily of approaches developed for other industries and needs. Low cost is also driven by standards, as opposed to proprietary solutions, so the system according to the present invention is very standards based. Only when proprietary approaches provide a special value, or parallel solutions can still operate, should proprietary approaches exist. One example is the key distribution portion of the security approach, when multiple solutions can exist in the same industry. Another example is in the compression technology selected for any particular system. If a consumer product standard is chosen, then pirates can more easily steal and access useful content. If the format is distinct from that of ordinary consumer electronics, then there is a natural protection based solely on the lack of cheap products to view stolen content.

The system approach according to the present invention employs security algorithms and compression approaches that are standards-based, and state of the art. MPEG-4 is presently preferred for video and audio compression and decompression, although it is implemented at (higher) bit rates and resolutions that place it beyond the reach of regular consumer electronic devices and personal computers. Thus, systems according to the present invention are able to use standards that are proven and known, yet nonetheless afford some resistance to pirates. RTP is presently preferred for transport over IP networks, either in real time or non-real time, which means that off-the-shelf software can be purchased, or nearly so. According to the present invention, content delivered to most theater servers are in the form of IP packets, which opens up a wide range of today's delivery networks and simultaneously allows for the use of off-the-shelf server technology. For example, in the present embodiment, video content is encrypted, and thus the transportation from the studio domain to the theater domain may be performed over the internet. In the present embodiment according to the present invention, triple DES and/or the Advanced Encryption Standard are used for encryption of the multi-media. These standards have withstood the tests of time, and thus encrypted packets delivered over IP networks will be well protected.

Theater side system design according to the present invention is based upon an important premise that the decryption of valuable content must be placed as closely as possible to the ultimate consumer point of “consumption”, in order to reduce piracy opportunities and also in order to leave ultimate control in the hands of the owners of the material, namely the studios. Therefore, a theater owner cannot decrypt content on his own; the equipment itself must be provisioned by the content owner to do so. To place the vital decryption process as closely as possible to the viewing point, it is placed inside the very expensive digital projector itself according to the present invention, which sits in each theater projection room. Because decryption occurs in the projector according to the present invention, so must decompression occur in the projector, and thus the interface between decrypted decompressed high quality video and the projection “guns,” or silicon mirrors or LCD light valves or whichever projection technology is employed, is secured. Projector specific watermarking occurs in the same location according to the present invention, for the ultimate in confidence that the watermarked viewed movie was viewed in the exact theater in which the projector was mounted. Optionally, a GPS circuit is embedded in the projector for increased confidence that the physical location of the projector is known.

Unfortunately, conventional digital cinema projector technology is not yet at the desired ultimate quality for viewing. For example, some feel that modern digital cinema projectors cannot yet achieve the quality delivered by a movie film copy that is properly shot and not yet worn down by repeated playing. Therefore, it is reasonable to assume that digital cinema projectors will continue to change in the future.

As digital cinema projector video quality and resolution improve over time, so must the resolution delivered to that projector. Modern compression and decompression hardware will also evolve to provide better and better quality and resolution. Modern decryption, watermarking, and key management will also evolve over time so as to provide improved watermarks, more secure key management, and faster or more secure decryption.

These three evolution may be in parallel, or they may occur separately. In either case, it is necessary to decouple them from one another so that each technology can improve on its own. In accordance with the present invention, a theater owner is able to upgrade the projector without upgrading all the security, decompression, watermarking, and key management. In terms of cost, these divide nicely between the projection system and all other components of the theater and studio.

Therefore, according to the present invention, the decryption, decompression, key management, and watermarking are integrated as a single hardware/software module, which is replaceable in the theater projector. Projectors are typically too large and too valuable to send to a factory to upgrade the module. Therefore, the security module according to the present invention is self-contained, surrounded by a secure envelope for tamper protection and identification, and locked onto or inside the projector body via a physically secure approach, such as a key. For further security according to the present invention, the module should have a connection path to the IP network, so that the module can inform the content owner of any attempts to remove it or tamper with it. A variety of techniques are suitable for use in conjunction with the present invention, such as power loss detection, and automatic reporting, so that if the unit is cut off from the content owners or the key management system, silence is interpreted as a violation.

With the approach according to the present invention, all the usual forms of secure access are provided: such as subscription access, pay-per-view access, and store and forward access, and the key management system is operable in a broadcast mode where report back is infrequent, or a full IP network two way mode, in which continuous communication with the key management system occurs.

The module according to the present invention receives IP packets with MPEG video and audio content, decrypts the IP packets, and then decompresses them inside the module. The module according to the present invention receives key management messages from the key management centers, and processes them for proper access to video content. For additional security according to the present invention, a watermark specific to the projector is additionally added inside the module. Optionally, a watermark provided by the content owner is also processed and evaluated for the conditions under which the content may be decrypted and thus viewed. The combination of the module according to the present invention being tamper-resistant, and collocated and locked onto or within the projector, prevents a pirate from accessing the clear digital content electronically. If any pirate films the displayed movie, such as with a portable camera, as is common today, the projector-specific watermark is present for identification of the exact theater from which the theft occurred.

Alternatively according to the present invention, if the projector manufacturers cannot be prevailed upon to provide a location and power for such a security module, the same goals can be achieved. For example, the module may be after-market mounted either under or along side the projector, and physically “locked” to it. The clear analog or digital video interfaces to the projector are buried through the mounting process according to the present invention, because that interface carries the signals that represent the clear content. As yet another alternative, the security module need not be physically coupled to the projection unit. By placing the decryption, decompression, and watermarking all together in a secure tamper resistant module/unit according to the present invention, the content owner finally has the confidence that at least the following objectives are accomplished. First, a pirate has access to only very high rate digital content at the interface, making the job of recording it very challenging. Secondly, if the video content is stolen in digital form, the watermark is present. Thirdly, modular upgrade of the security module is relatively easy for the theater.

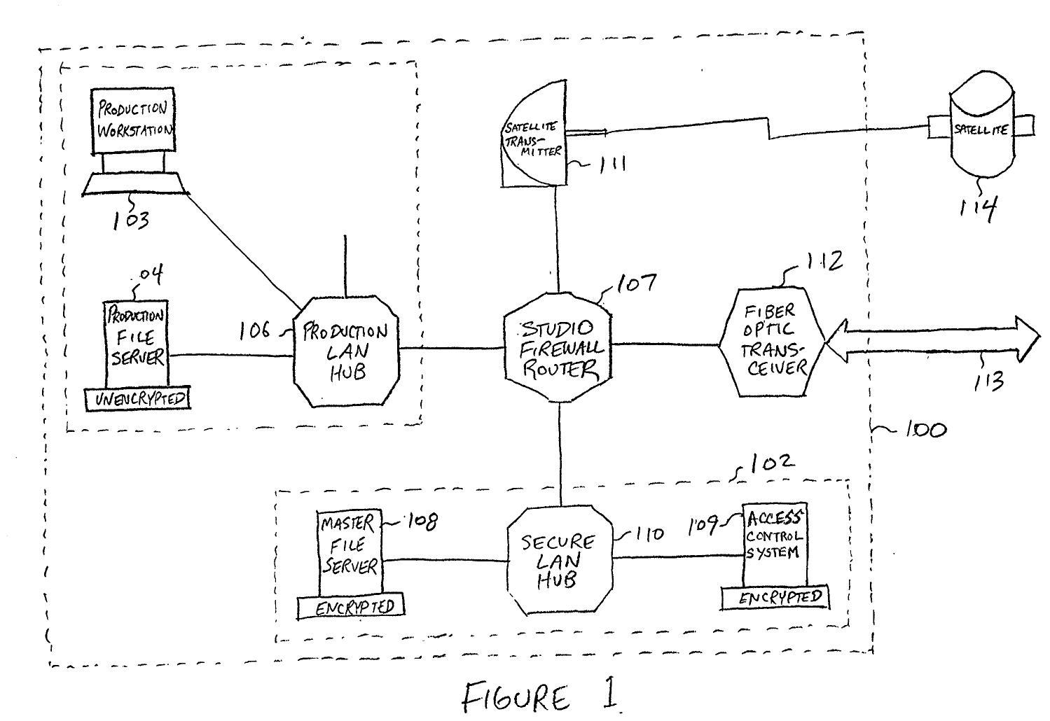

FIG. 1 is an exemplary block diagram of a studio domain 100 in which encrypted compressed digital video content is distributed in accordance with an embodiment of the present invention. The studio domain 100 is the content source for the a projection system. The studio domain 100 includes a production domain 101 and a storage domain 102. The production domain 100 includes one or more production workstations 103, a production file server 104, and a production central processing unit 105. The files in the production file server 104 are preferably unencrypted. A production local area network hub 106 ties the workstation 103, and file server 104, together. A studio firewall router 107 provides connectivity between the production domain 101 and the storage domain 102. The storage domain 102 is preferably a secure domain, in which the files stored therein are encrypted. The storage domain 102 includes a master file server 108 and access control system 109 which is tied together with a secure local area network hub 110. Encryption of files for storage, and encryption of content for distribution, and key management for the secure module in the theater are all controlled and executed by the access control system 109. The studio firewall router 107 allows communications of encrypted compressed digital video content out of the storage domain 100 of the studio domain 100 preferably through a satellite transmitter 111 to a communications satellite 114. Alternatively, the studio firewall router 107 transmits through a fiber optic transceiver 112 across a terrestrial link 113 out of the storage domain 102 of the studio domain 100. The studio domain 100 may also receive messages from the outside world through the terrestrial link 113 through the fiber optic transceiver 112.

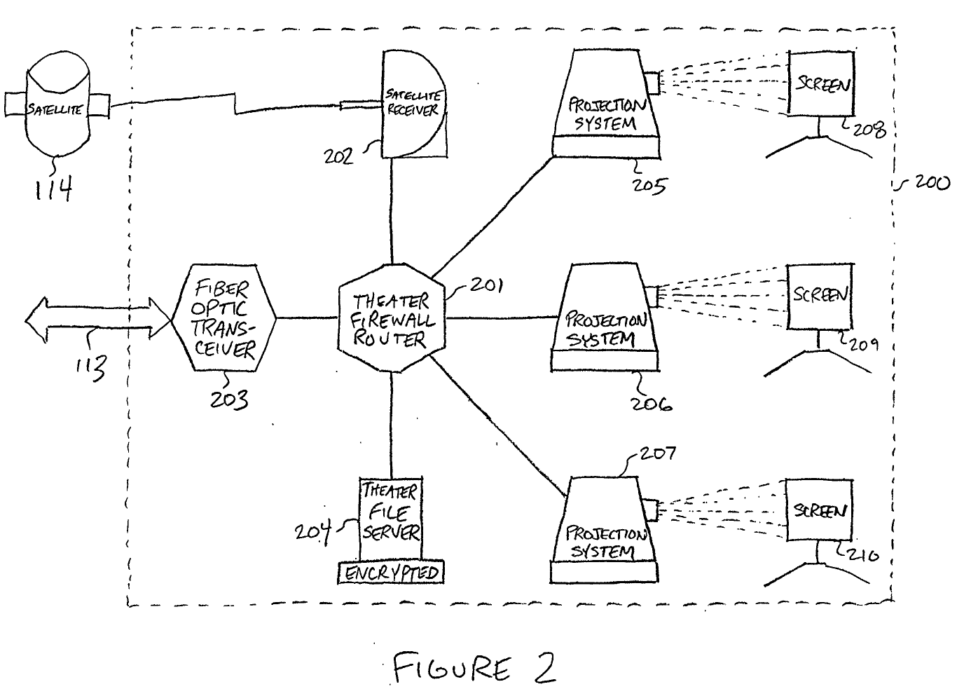

FIG. 2 is an exemplary block diagram of a theater complex domain 200 in which encrypted compressed digital video content can be received in accordance with an exemplary embodiment of the present invention. A theater firewall router 201 allows the encrypted compressed digital video content to be received from the content source (studio domain 100). If the studio domain 100 transmits to the satellite 114, then the satellite receiver 202 in the theater complex domain 200 receives the encrypted compressed digital video content from the satellite 114. Alternatively, if the studio domain 100 transmits through the terrestrial link 113, then the fiber optic transceiver 203 receives the encrypted compressed digital video content. In the present embodiment, the encrypted compressed digital video content is received prior to any rendering of the video content to an audience, and is stored in the theater file server 204 in its received encrypted form. When it is time for a showing of the stored video content by one or more of the projection systems 205, 206, and 207 onto their respective viewing screens 208, 209, and 210 in three separate theaters within the theater complex domain 200, the encrypted compressed digital video content is transmitted to the requesting projection system (205, 206, or 207) through the theater firewall router 201.

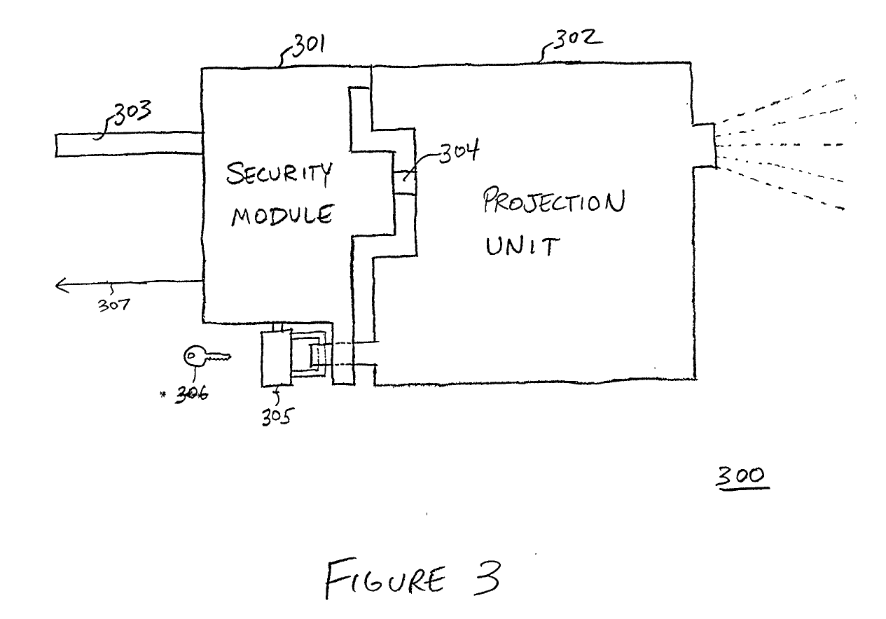

FIG. 3 is an exemplary block diagram of a projection system 300 in accordance with an embodiment of the present invention. A security module 301 is removably coupled to a projection unit 302 which projects a visual image onto a screen (not shown). In the present embodiment, an input link 303 carries encrypted compressed digital video content to the security module. Within the security module 301, the encrypted compressed digital video content is processed so that unencrypted decompressed digital video content having a projector-specific watermark embedded therein is delivered to the projection unit 302 through the communication link 304. According to the present invention, the security module 301 is physically attached to the projection unit 302, or located within unit 302, and is physically locked to the projection unit 302 using a locking device 305. A physical key 306 is required in order to gain entry into the security module 301 or to detach the security module 301 from the projection unit 302. A transmitter to a connection path 307 to an IP network from which the content source can be contacted is included according to the present invention so that the security module 301 can contact the content source to report usage information, or in the event of any attempts to tamper with the security module 301 or lock 305. The connection path 307 and input link 303 may be combined as a single connection to a local area network over which theater domain communications are performed.

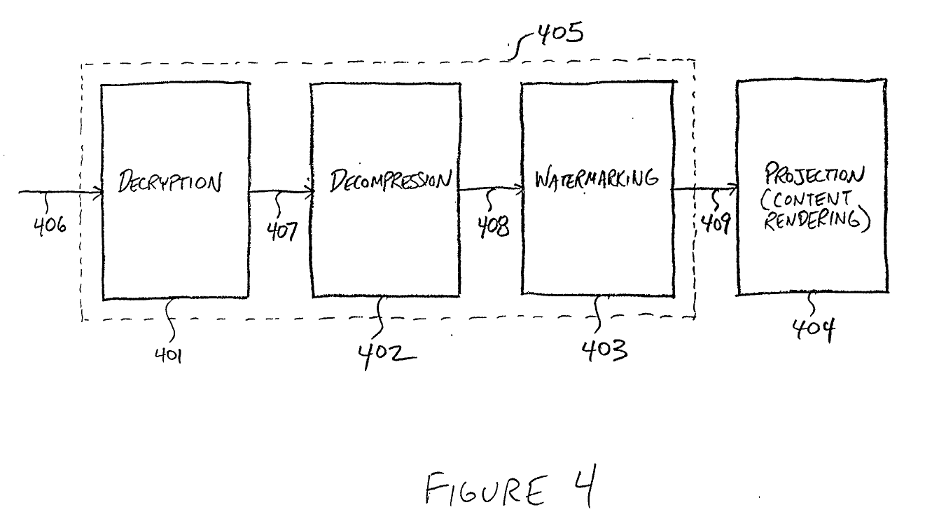

FIG. 4 illustrates an exemplary functionality performed within the projection system 300 of FIG. 3. The encrypted compressed digital video content 406 is first decrypted by the decryption unit 401 so as to produce decrypted compressed digital video content 407. The decrypted compressed digital video content 407 is then decompressed by the decompression unit 402 so as to produce decrypted decompressed digital video content 408. The watermarking unit 403 embeds a watermark into the decrypted decompressed digital video content 408 to produce decrypted decompressed digital video content having a watermark embedded therein 409. Alternatively, watermarking may occur after decryption and prior to decompression. The projection unit 404 renders the decrypted decompressed digital video content onto a screen.

While the present invention has been described with reference to its presently preferred and alternative embodiments, those skilled in the art will be enabled by this disclosure to make various additions, substitutions, and modifications to embodiments illustrated and described without departing from the spirit and scope of the present invention. Accordingly, those additions, substitutions, and modifications are deemed to lie within the spirit and scope of the present invention, as delineated by the appended claims.

What is claimed is:

1. A theater complex domain comprising:
a projection unit operable to render decompressed digital video content;
a security module having a decompression unit operable to receive compressed digital video content and to produce the decompressed digital video content;
the compressed digital video content received by the decompression unit comprises unencrypted compressed digital video content, and the decompressed digital video content rendered by the projection unit comprises unencrypted decompressed high bit-rate digital video content; and
the security module having a decryption unit for receiving encrypted compressed digital video content and to produce the unencrypted compressed digital video content.

2. A theater complex domain as in claim 1,
wherein the security module further comprises:
a watermark unit coupled to the decompression unit operable to receive the decompressed digital video content produced by the decompression unit and to produce the decompressed digital video content rendered by the projection unit,
wherein the decompressed digital video content rendered by the projection unit includes a watermark embedded therein.

3. A theater complex domain as in claim 2,
wherein the watermark uniquely identifies the projection unit to which the security module is removably coupled.

4. A theater complex domain as in claim 1,
wherein the security module is physically locked in a tamper resistant container.

5. A theater complex domain as in claim 4,
wherein the security module is physically locked to the projection unit to which it is removably coupled.

6. A theater complex domain as in claim 1,
wherein a global positioning circuit is embedded in the security module.

7. A theater complex domain as in claim 1, further comprising:
a receiver coupled to the security module operable to receive the compressed digital video content from a content source.

8. A theater complex domain as in claim 7,
wherein the receiver is operable to receive the compressed digital video content from the content source in real-time, and is operable to transmit the compressed digital video content to the security module, such that the projection unit renders digital video content corresponding to the compressed digital video content nearly concurrently with reception by the receiver of the compressed digital video content.

9. A theater complex domain as in claim 8, further comprising:
a file server coupled to the receiver and the security module, the file server being operable to store the compressed digital video content received from the receiver, and being operable at a later time or times to provide the compressed digital video content to the security module for rendering by the projection unit;
wherein the receiver is operable to receive the compressed digital video content from the content source, and is operable to transmit the compressed digital video content to the file server.

10. A theater complex domain as in claim 7,
wherein the receiver is a satellite receiver.

11. A theater complex domain as in claim 7,
wherein the receiver is a fiber optic transceiver.

12. A theater complex domain as in claim 7,
wherein the compressed digital video content is received by the receiver in the form of internet protocol packets.

13. A theater complex domain as in claim 12, further comprising:
a transmitter coupled to the security module operable to transmit information ultimately to the content source.

14. A theater complex domain as in claim 13,
wherein the security module is operable to detect unauthorized attempts to tamper with it; and
wherein the information transmitted to the content source includes notification of unauthorized attempts to tamper with it.

15. A theater complex domain as in claim 14,
wherein the security module is operable to periodically report to the content source.

16. A theater complex domain as in claim 14,
wherein the transmitter and receiver are embedded in a transceiver unit.

17. A theater complex domain as in claim 16,
wherein the security module and transceiver are coupled together by an internet protocol network.

18. A security module for a projection unit, comprising:
a decompression unit operable to receive compressed digital video content and to produce decompressed digital video content; and
a security container coupled to and enclosing the decompression unit, wherein the security container is physically removably coupled to the projection unit.

19. A security module as in claim 18, further comprising:
a watermarking unit for producing decompressed digital video content having a watermark embedded therein.

20. A security module as in claim 19,
wherein the watermark embedded in the decompressed digital video content produced by the watermarking unit uniquely identifies the projection unit to which the security module is removably coupled.

21. A security module as in claim 19,
wherein the watermark embedded in the decompressed digital video content produced by the watermarking unit uniquely identifies the security module.

22. A security module as in claim 18,
wherein the compressed digital video content received by the decompression unit comprises unencrypted compressed digital video content, and wherein the decompressed video content produced by the decompression unit comprises unencrypted decompressed video content, the security module further comprising:
an encryption unit coupled to the decompression unit operable to receive encrypted compressed digital video content and to produce the unencrypted compressed digital video content.

23. A security module as in claim 19, further comprising:
a connection path for the security module to communicate to a content source.

24. A security module as in claim 23, wherein the security module is operable to periodically report information to the content source.

25. A method of displaying digital video content, the method comprising the steps of:
receiving compressed digital video content from a content source;
transmitting the compressed digital video content to a security module removably coupled to a projection unit;
decompressing the compressed digital content within the security module so as to produce decompressed digital video content; and
rendering the decompressed digital video content by the projection unit.

26. A method of displaying digital video content as in claim 25,
wherein compressed digital video content from the content source comprises encrypted compressed digital video content, wherein the compressed digital video content decompressed within the security module comprises unencrypted compressed digital video content, the method further comprising the steps of:
decrypting the encrypted compressed digital video content so as to produce the unencrypted compressed digital video content.

27. A method as in claim 25, further comprising the step of:
after the transmitting and prior to the rendering step, watermarking within the security module the digital video content with an embedded watermark.

28. A method as in claim 27,
wherein the embedded watermark comprises a unique identifier of the projection unit to which the security module is removably coupled.

29. A method as in claim 27,
wherein the embedded watermark comprises a unique identifier of the security module.

30. A method as in claim 25,
wherein the receiving of the digital video content from the content source occurs in real-time nearly concurrently with the rendering of the decompressed digital video content by the projection system.

31. A method as in claim 25, further comprising the step of:
after the receiving step and prior to the transmitting step,
storing in a file server the compressed digital video content.

32. A method as in claim 25, further comprising the step of:
wherein the step of receiving the compressed digital video content is performed by receiving internet protocol packets containing the compressed digital video content.

33. The theater complex domain as in claim 2 wherein the watermark unit is coupled before or after the decompression unit.

34. The security module of claim 18 further comprising
a decryption unit for receiving encrypted compressed digital video content and to produce the unencrypted compressed digital video content.

35. A method for secure delivery and playback of content between a studio computing system and theater computing system, the method comprising:
encrypting the content at the studio computing system;
forwarding the encrypted content from the studio computing system to a theater computing system;
storing by the theater computing system, the encrypted content in memory;
playback of the encrypted content from the theater computing system to a projection unit; and
decryption of the encrypted content at a secure module located within a projection unit such that the act of decrypting is controlled at the studio computing system and the act of play back is controlled by the theater computing system.

36. The method of claim 35 further comprising decompression, key management, and watermarking by the secure module,
wherein the secure module is a single replaceable unit.
